(19) United States
(12) Patent Application Publication
(10) Pub. No.: US 2020/0401548 A1
(43) Pub. Date: Dec. 24, 2020

(54) EMBEDDED CONTROLLER, ELECTRONIC DEVICE, AND METHOD FOR FILTERING SPI BUS COMMAND IN RELATION TO WRITE PROTECTION

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: HUNG-CHI HUANG, New Taipei (TW)

(21) Appl. No.: 16/673,609

(22) Filed: Nov. 4, 2019

(30) Foreign Application Priority Data
Jun. 21, 2019 (CN) 201910544904.3

(51) Int. Cl. G06F 13/42; G06F 13/16; G06F 9/4401

(52) U.S. Cl. CPC G06F 13/4282; G06F 9/4401; G06F 13/1668; G06F 13/1642

(57) ABSTRACT

An embedded controller connected with a main control module through a first interface module is connected with an SPI storage through a second interface module. The main control module outputs SPI bus commands to an SPI storage through the embedded controller. The embedded controller includes an EC FW block and an SPI bus command filter module. The EC FW block stores at least one limited SPI bus command. The SPI bus command filter module can switch between an enable mode and a disable mode. In the enable mode, the SPI bus command filter module filters out the SPI bus command from the main control module based on the at least one limited SPI bus command, and blocks the SPI bus command, thus performing a write protection of the SPI storage.

### FIELD

The subject matter herein generally relates to data security and SPI command filter for write protection.

### BACKGROUND

A serial peripheral interface (SPI) is widely used in an electronic device. SPI flash memories in an electronic device can encounter issues due to data corruption caused by a damaged or modified BIOS, a virus attacking, a sudden power interruption, or other reason. Improved write protection for SPI flash memories is needed.

There is room for improvement in the art.

### BRIEF DESCRIPTION OF THE FIGURES

Implementations of the present disclosure will be described, by way of embodiment, with reference to the figures.

FIG. 1 is a block diagram view of an embodiment of an electronic device, the electronic device comprising an SPI bus command filter module.

FIG. 2 is a block diagram view of the SPI bus command filter module of FIG. 1.

FIG. 3 is a flowchart of an SPI bus command filter method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “substantially” is defined to be essentially conforming to the particular dimension, shape, or other feature that the term modifies, such that the component need not be exact. For example, “substantially cylindrical” means that the object resembles a cylinder but can have one or more deviations from a true cylinder. In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM, magnetic, or optical drives. It will be appreciated that modules may comprise connected logic units, such as gates and flip-flops, and may comprise programmable units, such as programmable gate arrays or processors, such as a CPU. The modules described herein may be implemented as either software and/or hardware modules and may be stored in any type of computer-readable medium or other computer storage systems. The term “comprising” means “including, but not necessarily limited to”; it specifically indicates open-ended inclusion or membership in a so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.” Embodiments of the present disclosure are described with reference to the drawings.

The present disclosure describes an electronic device with an SPI bus command filter function for performing a write protection.

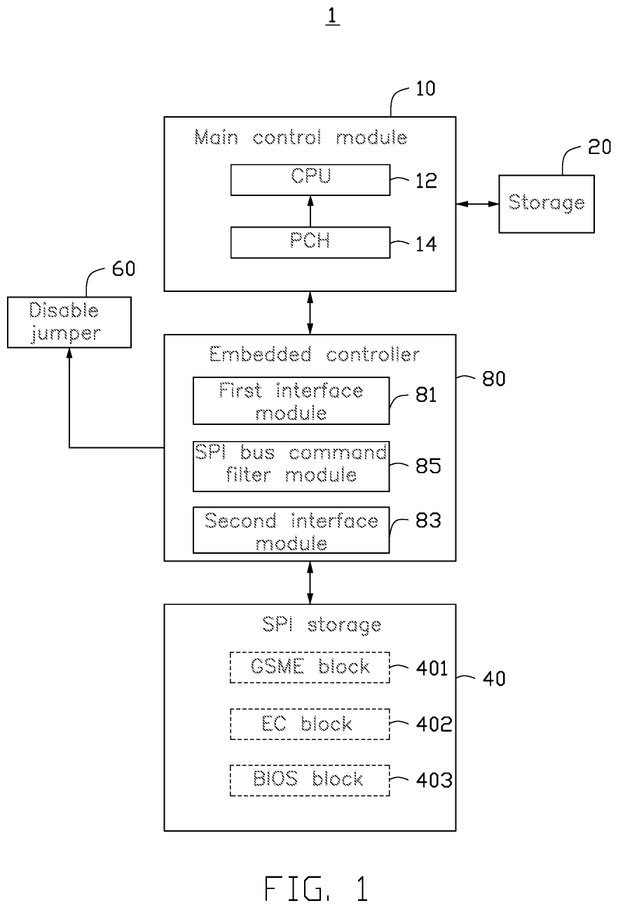

FIG. 1 shows a block diagram view of an electronic device 1. The electronic device 1 can be a mobile device, for example, a personal computer, a tablet PC, a mobile phone, a person digital assistant (PAD), a games machine, an internet protocol television (IPTV), a smart wearable device, and a navigation device display device. As another example, the electronic device 1 can be a fixed terminal, such as a desktop computer and a digital TV.

The electronic device 1 includes a main control module 10, a storage 20, an SPI storage 40, a disable jumper 60, and an embedded controller (EC) 80.

The main control module 10 is electrically connected with the storage 20. The main control module 10 executes instructions stored in the storage 20. The main control module 10 is connected with the SPI storage 40 through the EC 80. The main control module 10 can include one or more microprocessor or digital processor. The main control module 10 includes a central processor unit (CPU) 12 and a platform controller hub (PCH) 14 coupled to the CPU 12. The CPU 12 is an integrated circuit and is used as a processing core and a control core. The PCH 14 controls an input operation or an output operation of external elements. The PCH 14 is connected with the EC 80 through a master attached flash (MAF). The PCH 14 writes SPI bus signal into the SPI storage 40 through EC 80. The SPI bus signal can be a command set with a plurality of commands. The command set includes a block address codes and operating codes. In one embodiment, the main control module 10 is a micro controller.

The storage 20 is connected to the main control module 10. The storage 20 stores program codes. The storage 20 can be a non-volatile memory, such as a random-access memory (RAM) or a first in first out (FIFO) storage. The storage 20 also can be a storage device, for example a memory card, a trans-flash (TF) card, a smart media card, a secure digital card, and a flash card.

The SPI storage 40 is connected to the EC 80. The SPI storage 40 stores program codes. In one embodiment, the SPI storage 40 is a read only memory, such as an SPI flash. The SPI storage 40 includes a converged security manageability engine (CSME) block 401, a BIOS block 402, and an EC firmware (EC FW) 403. The GSME block 401 stores GSME program codes. The BIOS block 402 stores a BIOS with a BIOS boot block. The EC FW 403 stores EC program codes and at least one limited SPI bus command. The EC program codes are executed by the EC 80.

The disable jumper 60 is connected to the EC 80. The disable jumper 60 can enable or disable the EC 80. The disable jumper 60 can switch between an enable state and a disable state. In other embodiments, the disable jumper 60 can be used for debugging the EC 80.

The EC 80 is connected to the main control module 10 and the SPI storage 40. The EC 80 can extract and execute specified program codes for performing a specified function, such as a power timing control, a power-on or power-off control, or a fan control, but is not limited. The EC 80 includes a first interface module 81 and a second interface module 83. The first interface module 81 establishes a connection between the EC 80 and the main control module 10. The second interface module 83 establishes a connection between the EC 80 and the SPI storage 40. In one embodiment, the EC 80 is an EC controller. Each of the first interface module 81 and the second interface module 83 is a serial peripheral interface (SPI) bus. In other embodiments, the first interface module 81 and the second interface module 83 are different types, for example, one of the first interface module 81 and the second interface module 83 can be an enhanced serial peripheral interface (eSPI) bus or a low pin count (LPC) bus.

The EC 80 can further include an SPI bus command filter module 85. The SPI bus command filter module 85 switches between an enable mode and a disable mode. During the enable mode, the SPI bus command filter module 85 filters the SPI bus commands based on the at least one limited SPI bus command for performing a write protection. During the disable mode, the SPI bus command filter module 85 stops filtering the SPI bus commands and directly outputs the SPI commands to the SPI storage 40 through the second interface 83. The SPI bus command filter module 85 can further rewrite the at least one limited SPI bus command.

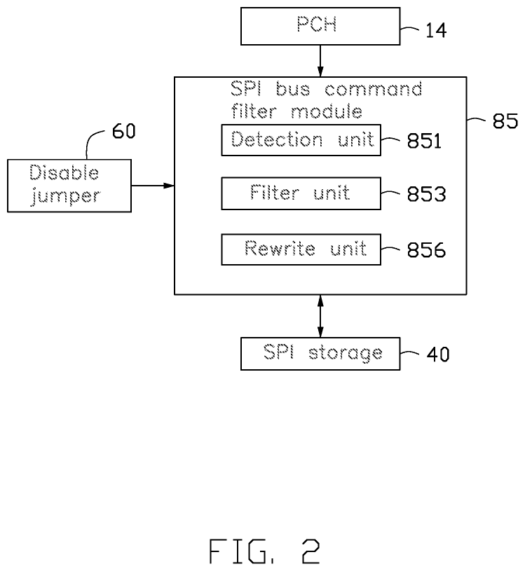

FIG. 2 shows a block diagram of the SPI bus command filter module 85.

The SPI bus command filter module 85 includes a detection unit 851, a filter unit 853, and a rewrite unit 856. The detection unit 851 detects the state of the disable jumper 60 and outputs a control signal. When the disable jumper 60 is enabled, the detection unit 851 outputs a disable control signal for disabling the filter unit 853. When jumper 60 is disabled, the detection unit 851 can output an enable control signal for enabling the filter unit 853. In one embodiment, the enable control signal is a high level voltage signal, and the disable control signal is a low level voltage signal. In other embodiments, both the enable control signal and the disable control signal can be high level signals, but the voltages of the SPI bus command filter module are different.

The filter unit 853 compares the SPI bus commands with the at least one limited SPI bus command based on the enable control signal. When the SPI bus commands include the at least one limited SPI bus command, the SPI bus commands are considered as illegal SPI bus commands, and the filter unit 853 blocks SPI bus commands and thus carries out write protection. When the SPI bus commands are without the at least one limited SPI bus commands, the SPI bus commands are considered as legal SPI bus commands, and the filter unit 853 outputs all SPI bus commands to the SPI storage 40 through the second interface module 83. The at least one limited SPI bus commands being executed will cause the address codes or the operation codes of the BIOS block 402 in the SPI storage 40 to be rewritten.

The filter unit 853 further stops comparing the SPI bus commands with the at least one limited SPI bus command based on the disable control signal and directly outputs the SPI bus commands to the SPI storage 40.

The rewrite unit 856 rewrites the at least one limited SPI bus command stored in the EC FW block of the SPI storage 40. In one embodiment, the rewrite operation can be add, delete, or amend.

Thus the PCH 14 connects with the SPI storage 40 through the EC 80, and the EC 80 with the SPI bus command filter module 85 filters the SPI bus command for performing a write protection of the SPI storage, thus data corruption in the SPI storage 40 caused by a damaged or modified BIOS, a virus attacking, a sudden power interruption, or other reasons is avoided.

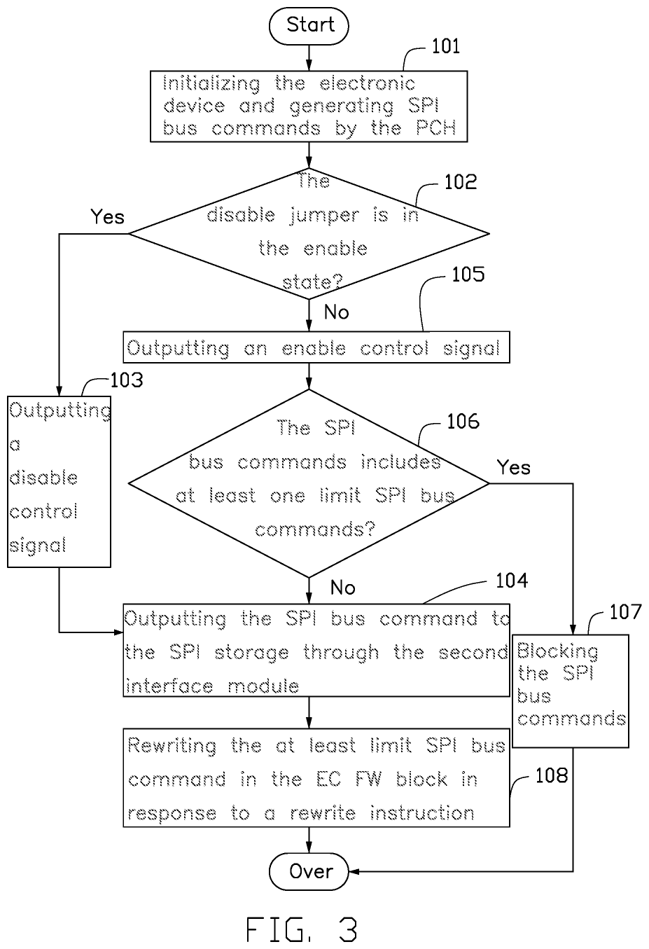

FIG. 3 shows an SPI bus command filter method in an electronic device 1. In one embodiment, the electronic device 1 can be a mobile device, for example, a personal computer, a tablet PC, a mobile phone, a person digital assistant (PAD), a games machine, an internet protocol television (IPTV), a smart wearable device, and a navigation device display device. As another example, the electronic device 1 can be a fixed terminal, such as a desktop computer and a digital TV. The electronic device 1 includes a main control module 10, a storage 20, an SPI storage 40, a disable jumper 60, and an embedded controller (EC) 80. The main control module 10 includes a central processor unit (CPU) 12 and a platform controller hub (PCH) 14 coupled to the CPU 12. The EC 80 includes a first interface module 81, a second interface module 83, and an SPI bus command filter module 85. The SPI bus command filter module 85 includes a detection unit 851, a filter unit 853, and a rewrite unit 856. The method may comprise at least the following steps, the steps may be re-ordered:

Step 101, initializing the electronic device 1 and generating SPI bus commands by the PCH 14.

Step 102, detecting whether the disable jumper 60 is in the enable state.

Step 103, outputting a disable control signal when the disable jumper 60 is enabled, for disabling a filter function of the filter unit 853.

Step 104, outputting the SPI bus command to the SPI storage 40 through the second interface module 83. In one embodiment, the SPI bus signal can be a command set with a plurality of commands. The command set includes block address codes and operating codes.

Step 105, outputting an enable control signal when the disable jumper 60 is disabled, for controlling the filter unit 853 to execute the filter function.

Step 106, determining whether the SPI bus commands of the PCH 14 include the at least one limited SPI bus command.

Step 107, when the SPI bus command includes the at least one limited SPI bus command, blocking the SPI bus commands to perform a write protection.

When the SPI bus command of the PCH 14 does not include the at least one limited SPI bus command, the process returns to Step S104.

Step 108, rewriting the at least one limited SPI bus command in the EC FW block in response to a rewrite instruction. In one embodiment, the rewrite operations can be add, delete, or amend.

The PCH 14 connects with the SPI storage 40 through the EC 80, and the EC 80 with the SPI bus command filter module 85 filters the SPI bus command for performing a write protection of the SPI storage, thus data corruption in the SPI storage 40 caused by a damaged or modified BIOS, a virus attacking, a sudden power interruption, or other reasons is avoided.

While various and preferred embodiments have been described the disclosure is not limited thereto. On the contrary, various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. An embedded controller connected with a main control module through a first interface module, and connected with an SPI storage through a second interface module; the main control module outputting SPI bus commands to the SPI storage through the embedded controller; the embedded controller comprising:
a BIOS block configured to store program codes;
a EC FW block configured to store at least one limited SPI bus command; and
an SPI bus command filter module configured to filter the SPI bus command;
wherein the SPI bus command filter module is capable of switching between an enable mode and a disable mode; in the enable mode, the SPI bus command filter module filters the SPI bus command from the main control module based on the at least one limited SPI bus command, and blocks the SPI bus command for performing a written protection of the SPI storage when the SPI bus commands with the at least one limited SPI bus command.

2. The embedded controller of claim 1, wherein the embedded controller further connected with a disable jumper; the disable jumper switches between an enable state and a disable state; the disable jumper controls the embedded controller to switch between the enable mode and the disable mode.

3. The embedded controller of claim 2, wherein the SPI bus command filter module comprises a detection unit and a filter unit; the detection unit detects whether the disable jumper is in the enable state; when the disable jumper is in the enable state, the detection unit outputs a disable control signal, and the filter unit directly outputs the SPI bus commands to the SPI storage based on the disable control signal; when the disable jumper is in the disable state, the detection unit outputs an enable control signal, and the filter unit compares the SPI bus command with the at least one limited SPI bus command based on the enable control signal.

4. The embedded controller of claim 1, wherein the SPI bus command filter module further comprises a rewrite unit; the rewrite unit rewires the at least one limited SPI bus command in the EC FW block in response to a rewrite instruction.

5. An electronic device comprising:
a main control module comprising a CPU and a PCH; the PCH configured to generate SPI bus commands;
an SPI storage comprising a BIOS block and an EC FW block; the BIOS block; the BIOS block configured to store program codes, and the EC FW block configured to store at least one limited SPI bus command; and
an embedded controller configured to connect with PCH through a first interface module, and connect with the SPI storage through a second interface module;
wherein the embedded controller further comprises an SPI bus command filter module; the SPI bus command filter module is capable of switching between an enable mode and a disable mode; in the enable mode, the SPI bus command filter module filters the SPI bus command from the main control module based on the at least one limited SPI bus command, and blocks the SPI bus command for performing a written protection of the SPI storage when the SPI bus commands with the at least one limited SPI bus command.

6. The electronic device of claim 5, wherein the embedded controller further connected with a disable jumper; the disable jumper switches between an enable state and a disable state; the disable jumper controls the embedded controller to switch between the enable mode and the disable mode.

7. The electronic device of claim 6, wherein the SPI bus command filter module comprises a detection unit and a filter unit; the detection unit detects whether the disable jumper is in the enable mode; when the disable jumper is in the enable state, the detection unit outputs a disable control signal, and the filter unit directly outputs the SPI bus commands to the SPI storage based on the disable control signal; when the disable jumper is in the disable state, the detection unit outputs an enable control signal, and the filter unit compares the SPI bus command with the at least one limited SPI bus command based on the enable control signal.

8. The electronic device of claim 5, wherein the SPI bus command filter module further comprises a rewrite unit; the rewrite unit rewires the at least one limited SPI bus command in the EC FW block in response to a rewrite instruction.

9. A SPI bus command filter method provided to an electronic device for performing a write protection; the electronic device comprising a main control module, an SPI storage, and an embedded controller; the embedded controller comprising an SPI bus command filter module; the SPI bus command filter module comprising a detection unit and a filter unit; the SPI storage comprising a BIOS block and a EC FW block; the BIOS block storing operation codes; the EC FW block storing at least one limited SPI bus command; the SPI bus command filter method comprising:
initializing the electronic device and generating SPI bus commands by a PCH of the main control module;
detecting whether a disable jumper is in an enable state;
outputting an enable control signal when the disable jumper is in a disable state;
determining whether the SPI bus command comprises the at least one limited SPI bus command based on the enable control signal;
blocking the SPI bus command when the SPI bus command comprises the at least one limited SPI bus command.

10. The SPI bus command filter method of claim 9, further comprising:
outputting a disable control signal for disabling a filter function of the filter unit when the disable jumper is in the enable state;
outputting the SPI bus command to the SPI storage through the second interface module.

11. The SPI bus command filter method of claim 9, further comprising:
outputting the SPI bus command to the SPI storage through the second interface module when the SPI bus command without the at least one limited SPI bus command.

12. The SPI bus command filter method of claim 9, further comprising:
rewriting the at least one limited SPI bus command in response to a rewrite instruction.
